(19) United States
(12) Patent Application Publication
(10) Pub. No.: US 2017/0113460 A1
(43) Pub. Date: Apr. 27, 2017

(54) INKJET HEAD AND INKJET PRINTER

(71) Applicant: TOSHIBA TEC KABUSHIKI KAISHA, Tokyo (JP)

(72) Inventors: Isao Suzuki, Mishima Shizuoka (JP); Masaya Ichikawa, Kannami Tagata Shizuoka (JP); Noriyuki Kikuchi, Mishima Shizuoka (JP)

(21) Appl. No.: 15/242,797

(22) Filed: Aug. 22, 2016

(30) Foreign Application Priority Data
Oct. 27, 2015 (JP) 2015-210706
May 24, 2016 (JP) 2016-103095

(51) Int. Cl. B41J 2/045; B41J 2/14; B41J 2/155

(52) U.S. Cl. CPC B41J 2/04581; B41J 2/04596; B41J 2/04541; B41J 2/155; B41J 2/14201

(57) ABSTRACT

In accordance with an embodiment, an inkjet head comprises a plurality of first driving elements containing a plurality of first pressure chambers respectively communicating with a plurality of first nozzles; a plurality of second driving elements containing a plurality of second pressure chambers respectively communicating with a plurality of second nozzles; a common liquid chamber configured to communicate with a plurality of the first pressure chambers and a plurality of the second pressure chambers; and a controller configured to apply an ejection pulse to the plurality of first driving elements and at least one non-ejection pulse to the plurality of second driving elements before an end time of the ejection pulse.

### CROSS-REFERENCE TO RELATED APPLICATION

The present application is based upon and claims the benefit of priorities from Japanese Patent Application No. P2015-210706 filed on Oct. 27, 2015 and Japanese Patent Application No. P2016-103095 filed on May 24, 2016, the entire contents of which are hereby incorporated by reference.

### FIELD

Embodiments described herein relate generally to an inkjet head and an inkjet printer and associated methods of printing.

### BACKGROUND

An inkjet head of an inkjet printer is equipped with a plurality of ejection areas each of which is composed of a plurality of pressure chambers communicating with one nozzle. The plurality of the ejection areas ejects ink onto a print medium such as a paper at different timing. For example, the inkjet head ejects the ink from a next, ejection area after ejecting the ink from an initial ejection area.

### DESCRIPTION OF THE DRAWINGS

FIG. 1 is a diagram illustrating an example of the configuration of an inkjet printer according to an embodiment;

FIG. 2 a perspective view of an inkjet head according to the embodiment;

FIG. 3 is a cross-sectional view of the inkjet head according to the embodiment;

FIG. 4 is an exploded perspective view illustrating the exploded inkjet head according to the embodiment;

FIG. 5 is a cross-sectional view of the inkjet head according to the embodiment;

FIG. 6 is a cross-sectional view of the inkjet head along a thickness direction of a nozzle plate according to the embodiment;

FIG. 7 is a diagram illustrating an example of operations of the inkjet head according to the embodiment;

FIG. 8 is a diagram illustrating an example of the operations of the inkjet head according to the embodiment;

FIG. 9 is a timing chart illustrating an example of a pulse applied to the inkjet head according to a first embodiment;

FIG. 10 is a timing chart illustrating another example of the pulse applied to the inkjet head according to the first embodiment;

FIG. 11 is a timing chart illustrating a concrete example of the pulse applied to the inkjet head according to the first embodiment;

FIG. 12 is a diagram illustrating a relation between a non-ejection pulse width and ejection failure according to the embodiment; and

FIG. 13 is a cross-sectional view of another example of the configuration of the inkjet printer according to the embodiment.

### DETAILED DESCRIPTION

In some cases, the conventional inkjet head fails to eject the ink from the next ejection area due to an effect of nozzle negative pressure generated through an ejection operation from the initial ejection area.

In accordance with an embodiment, an inkjet head comprises a plurality of first driving elements, a plurality of second driving elements, a common liquid chamber and a controller. A plurality of the first driving elements constitutes a plurality of first pressure chambers respectively communicating with a plurality of first nozzles. A plurality of the second driving elements constitutes a plurality of second pressure chambers respectively communicating with a plurality of second nozzles. The common liquid chamber communicates with a plurality of the first pressure chambers and a plurality of the second pressure chambers. The controller applies an ejection pulse to the plurality of first driving element and at least one non-ejection pulse to the plurality of second driving element before an end timing of the ejection pulse.

In accordance with another embodiment, an inkjet printing method for the inkjet head involves applying simultaneously an ejection pulse to a plurality of first driving elements and a non-ejection pulse to a plurality of second driving elements.

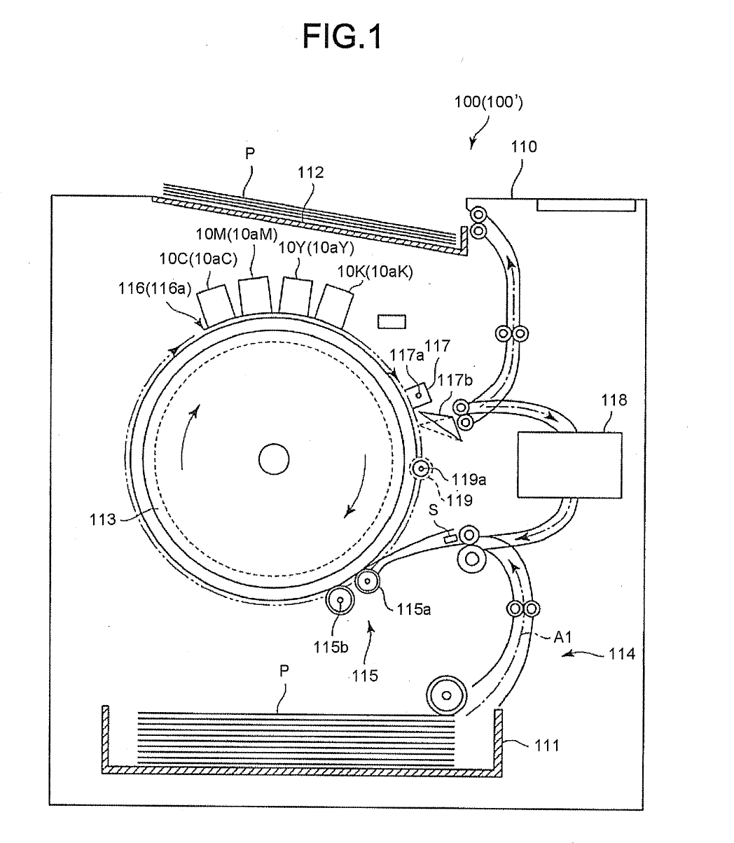

Hereinafter, the embodiment is described with reference to the accompanying drawings. FIG. 1 is a diagram illustrating an example of the configuration of an inkjet printer 100 according to the embodiment.

The inkjet printer 100 conveys a paper P as a print medium along a predetermined conveyance route and carries out various processing such as an image forming processing and the like. The inkjet printer 100 is equipped with an inkjet head 10, a housing 110, a paper feed cassette 111 as a paper supply section, a paper discharge tray 112 as a discharge section, a holding roller 113, a conveyance device 114 and a reversing device 118.

The housing 110 constitutes the contour of the inkjet printer 100. The paper feed cassette 111 is arranged inside of the housing 110. The paper feed cassette 111 stores a paper P. The paper discharge tray 112 is arranged above the housing 110. The paper discharge tray 112 discharges the paper P on which an image is formed.

The holding roller 113 (drum) holds the paper P on the outer surface thereof to rotate. The conveyance device 114 conveys the paper P along a predetermined conveyance path A1 formed from the paper feed cassette 111 to the paper discharge tray 112 via the outer circumference of the holding roller 113. The reversing device 118 reverses front and rear surfaces of the paper P peeled from the holding roller 113 to supply the reversed paper P to the surface of the holding roller 113 again.

The conveyance device 114 is equipped with a plurality of guide members and a plurality of rollers for conveyance arranged along the conveyance path A1. The rollers for conveyance include a pickup roller, a paper feed roller pair, a resist roller pair, a separation roller pair, a conveyance roller pair and a discharge roller pair. These rollers for conveyance are driven by a motor for conveyance to rotate to send the paper P to the downstream side along the conveyance path A1.

Sensors S for monitoring conveyance states of the paper are arranged in various places of the conveyance path A1. The holding roller 113 rotates in a state of holding the paper P on the surface thereof to convey the paper P.

On the outer peripheral part of the holding roller 113, a holding device 115, a head unit 116, a discharge peeling device 117 and a cleaning device 119 are arranged in order from the upstream side to the downstream side.

The holding device 115 is equipped with a pressing roller 115a and a charging roller 115b. The pressing roller 115a presses the outer surface of the holding roller 113. The charging roller 115b generates (charges) electrostatic force of a direction which enables the paper P to be absorbed on the outer surface of the holding roller 113 through supplied electric power. The holding roller 113 absorbs the paper P through the electrostatic force.

The head unit 116 includes a plurality of (e.g., four colors) inkjet heads 10 oppositely arranged on the outer surface of the holding roller 113. For example, the head unit 116 is equipped with a cyan inkjet head 100, a magenta inkjet head 10M, a yellow inkjet head 10Y and a black inkjet head 10K. The inkjet heads 100, 10M, 10Y and 10K respectively eject ink from nozzle holes arranged at a predetermined pitch. The inkjet heads 100, 10M, 10Y and 10K discharge the ink to form an image on the paper P held on the outer surface of the holding roller 113. The inkjet head 10 (100, 10M, 10Y and 10K) is described in detail later.

The discharge peeling device 117 is equipped with a discharge roller 117a for discharging the electrostatic force of the paper P and a peeling claw 117b for peeling the paper P from the holding roller 113.

The cleaning device 119 is equipped with a cleaning member 119a that rotates in a state of contacting with the holding roller 113 to clean the holding roller 113.

The reversing device 118 reverses the paper P peeled from the holding roller 113 to supply the reversed paper P to the surface of the holding roller 113 again.

The inkjet printer 100 is further equipped with a controller, a ROM, a RAM and an I/F (interface). The controller (central control unit) is, for example, a processor such as a CPU. The ROM is a memory for storing various programs. The RAM is a memory for temporarily storing various variable data, image data and the like. The I/F (interface) inputs data from an external device or outputs data to the external device. Furthermore, the inkjet printer 100 may be further equipped with proper elements which are necessary or delete unnecessary elements.

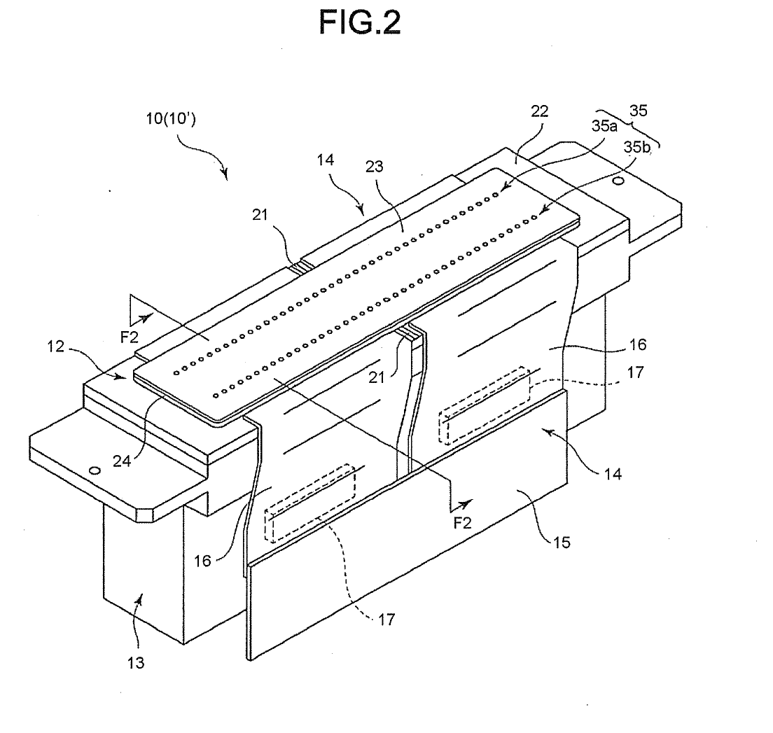

Next, the inkjet head 10 is described. Examples of the configuration of the inkjet head 10 are described hereinafter with reference to FIG. 2 to FIG. 6. The inkjet head 10 receives the supply of the ink (print member) from the inkjet printer 100 to form an image on the paper P as the print medium. The print member may be various kinds of ink for forming images. Further, the print member may be functional ink including various functions used except a function of forming an image.

The inkjet head 10 is connected with a tank (ink tank or liquid tank) loaded in the inkjet printer 100 via a tube. The inkjet head 10 receives the supply of the ink from the tank via the tube.

The inkjet head 10 is equipped with a head main body 12, a unit section 13 and a control circuit 14 (control section). The head main body 12 is formed on the unit section 13. The control circuit 14, which is arranged on the side surface of the unit section 13, sends a control signal to the head main body 12. The unit section 13 includes a manifold for forming a part of a route between the head main body 12 and the tank and a member for connecting with the inkjet printer 100.

As shown FIG. 2, the control circuit 14 includes a substrate main body 15 and a pair of film carrier packages (FCP) 16. The substrate main body 15 is a rectangular printed wiring board. Various electronic components and connectors are mounted in the substrate main body 15. Further, a pair of the FCPs 16 is mounted in the substrate main body 15.

Each of a pair of the FCPs 16 on which a plurality of wirings is formed includes a film made of resin having softness and an IC 17 connected with a plurality of the wirings. The film is, for example, tape automated bonding (TAB). A pair of the FCPs 16 is mounted from the substrate main body 15 along the side surface of the unit section 13 and connected with the head main body 12. The IC 17 is a member for applying a voltage to an electrode 34. The IC 17 is fixed on the film through the resin.

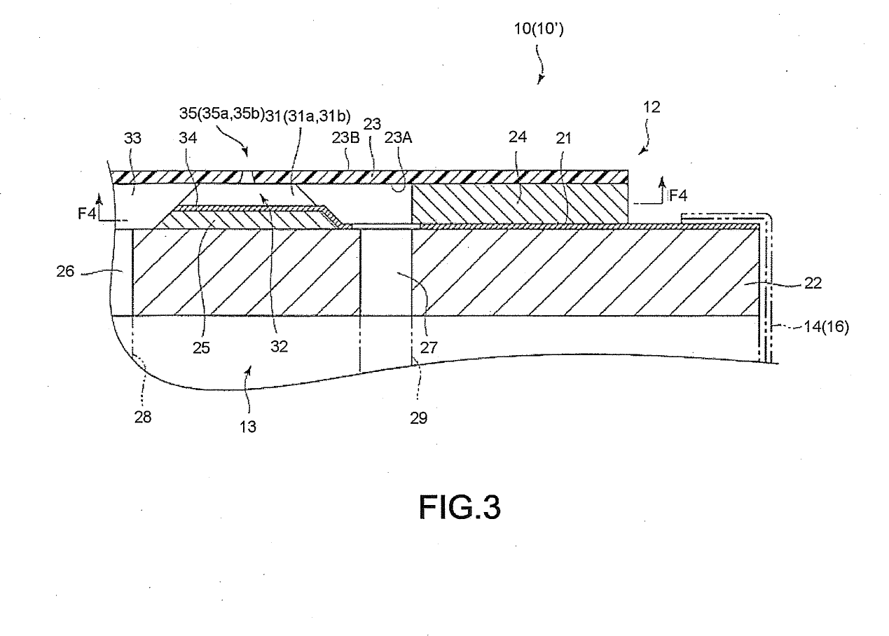

As shown in FIG. 3, an end part of the FCP 16 can be connected with a wiring pattern 21 on a base plate 22 by thermocompression bonding through an anisotropic conductive film (ACF). Through the ACF, a plurality of wirings of the FCP 16 is electrically connected with the wiring pattern 21.

The head main body 12 ejects a liquid drop (e.g., ink drop) onto the print medium (paper P). FIG. 3 is a cross-sectional view of the inkjet head 10 taken along a F2-F2 line. As shown in FIG. 3, the head main body 12 is equipped with the base plate 22, a nozzle plate 23, a frame member 24 and a block 25 in which a plurality of driving elements 31 is formed.

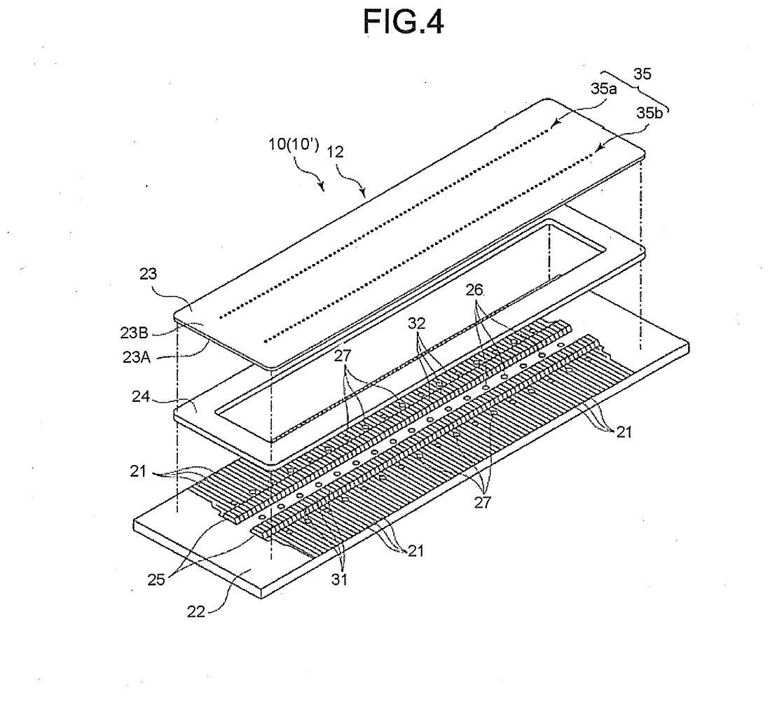

As shown in FIG. 3 and FIG. 4, the base plate 22 is formed into a rectangular plate shape. The base plate 22 is made from, for example, ceramic like alumina. A plurality of supply holes 26 and a plurality of discharge holes 27 penetrate the base plate 22.

The supply holes 26 are arranged in parallel substantially at the center of the base plate 22 in a longitudinal direction of the base plate 22. The supply hole 26 communicates with an ink supply section 28 of the manifold of the unit section 13. The supply hole 26 is connected with the tank via the ink supply section 28. The discharge holes 27 are arranged in parallel at two sides of the base plate 22 across the supply hole 26 in the longitudinal direction of the base plate 22. The discharge hole 27 communicates with an ink discharge section 29 of the manifold of the unit section 13. The discharge hole 27 is connected with the tank via the ink discharge section 29.

The frame member 24 can be a square frame-shaped member. The frame member 24 is made from, for example, nickel alloy. The frame member 24 interposes between the base plate 22 and the nozzle plate 23. The frame member 24 is respectively bonded with a mounting surface and the nozzle plate 23.

The driving element 31 is formed by two piezoelectric bodies. The driving element 31 includes two plate-like piezoelectric bodies formed by, for example, lead zirconate titanate (PZT). The two piezoelectric bodies are bonded with each other in such a manner that their directions of polarization are opposite to each other in the thickness direction.

The block 25 in which a plurality of the driving elements 31 is formed is bonded on the mounting surface of the base plate 22. As shown in FIG. 3, the block 25 can be formed into a trapezoid. The top of the driving element 31 is bonded with the nozzle plate 23.

As shown in FIG. 4, the block 25 includes a plurality of grooves. The grooves respectively extend in a direction crossing with the longitudinal direction of the block 25 (longitudinal direction of the inkjet head 10). The plate-like driving elements 31 are separated by the grooves.

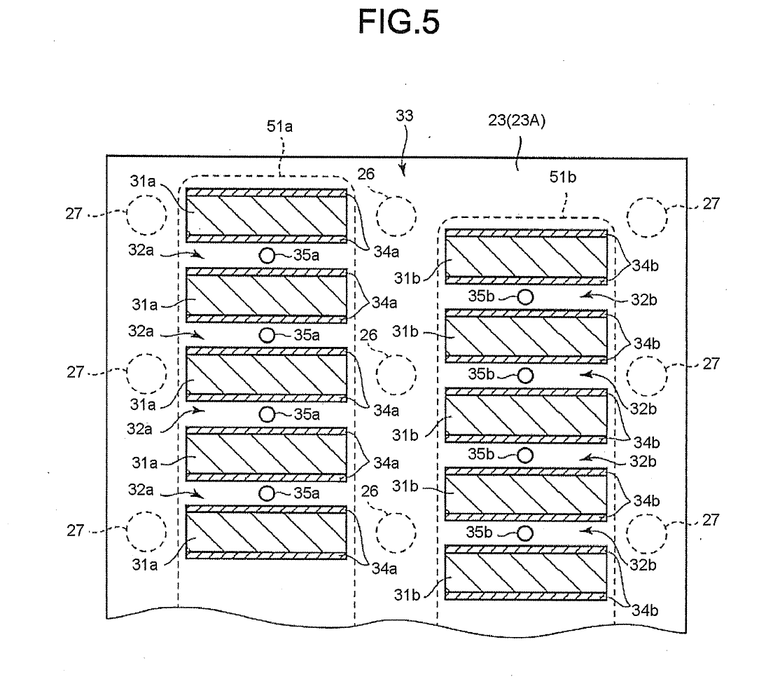

FIG. 5 is a cross-sectional view of the inkjet head 10 taken along a F4-F4 line. As shown in FIG. 5, the electrode 34 is arranged on both surfaces of the driving element 31. The electrode 34 covers the bottom of the groove and side surfaces of the driving element 31. The electrode 34 is formed by, for example, carrying out laser patterning on nickel thin film. The electrode 34 is electrically connected with the IC 17.

As shown in FIG. 4, a plurality of the wiring patterns 21 extending in a direction crossing with the longitudinal direction of the base plate 22 from a plurality of the driving elements 31 is arranged on the mounting surface of the base plate 22. The wiring pattern 21 is formed by, for example, carrying out the laser patterning on the nickel thin film formed on the base plate 22.

The nozzle plate 23 is formed with, for example, polyimide film, and is substantially rectangular. The nozzle plate 23 faces the base plate 22. The nozzle plate 23 includes a first surface 23A at a pressure chamber 32 side and a second surface 23B opposite to the first surface 23A.

The nozzle plate 23 includes a nozzle 35. The nozzle 35 penetrates the nozzle plate 23. The nozzle 35 is composed of a nozzle 35a (first nozzle) and a nozzle 35b (second nozzle). The nozzles 35a and 35b are respectively arranged in parallel along the longitudinal direction of the nozzle plate 23. Each pressure chamber 32 is equipped with one nozzle 35 (35a and 35b).

An area inside the groove arranged in the block 25 is the pressure chamber 32 facing the nozzle 35. The pressure chamber 32 is composed of the driving elements 31 that face each other, the base plate 22 and the nozzle plate 23. The pressure chamber 32 enables the liquid drop to be ejected from the nozzle 35 through an operation of the driving element 31. A common liquid chamber 33 supplies the liquid (e.g., ink) to each pressure chamber 32. As shown in FIG. 3, the common liquid chamber 33 is composed of the nozzle plate 23, a part of the base plate 22 in the vicinity of the supply hole 26 and the inclined planes portion of the block 25. The common liquid chamber 33 communicates with each pressure chamber 32.

As shown in FIG. 5, the inkjet head 10 is equipped with two rows (a plurality of rows) of driving elements 31 including one row of plural driving elements 31a and one row of plural driving elements 31b, arranged in one direction, which are parallel to each other. In FIG. 5, the inkjet head 10 is equipped with the driving elements 31a as the row at the left side and the driving elements 31b as the row at the right side. The longitudinal direction of the driving element 31 has an orthogonal relation to an arrangement direction of the driving element; however, the longitudinal direction may have a predetermined angle to the arrangement direction.

Two rows of ejection areas 51a and 51b are formed in parallel at both sides of the supply hole 26. The ejection area 51a is a first ejection area, and the ejection area 51b is a second ejection area. The ejection area 51a and the ejection area 51b are arranged at a predetermined interval. The ejection area 51a includes a plurality of the driving elements 31a, the electrodes 34a and the nozzles 35a. The ejection area 51b includes a plurality of the driving elements 31b, the electrodes 34b and the nozzles 35b.

The pressure chamber 32 (32a or 32b) is formed between the driving elements 31 (31a or 31b). The pressure chamber 32 is formed by two driving elements 31 and the electrodes 34 (34a or 34b) arranged on two surfaces of the driving element 31. The ink nozzle 35 for ejecting the ink is arranged substantially at the center of the longitudinal direction of the pressure chamber 32 on the nozzle plate 23. The longitudinal direction of the pressure chamber 32 is orthogonal to the arrangement direction of the driving element 31. The common liquid chamber 33 is arranged between the ejection area 51a and the ejection area 51b. The discharge hole 27 at one end side of the ejection area 51a and the supply hole 26 at the other end side thereof are arranged on the base plate 22. The supply hole 26 at one end side of the ejection area 51b and the discharge hole 27 at the other end side thereof are arranged on the base plate 22. A plurality of the supply holes 26 is arranged in the arrangement direction of the driving element 31. A plurality of rows of the plural discharge holes 27 is arranged in the arrangement direction of the driving element 31. The discharge hole 27 is arranged in the vicinity of the frame member 24.

The nozzle 35a communicates with the pressure chamber 32a (first pressure chamber) formed by the driving elements 31a (first driving elements) and the electrodes 34a arranged on the both surfaces of the driving element 31a. Further, the nozzle 35b communicates with the pressure chamber 32b (second pressure chamber) formed by the driving elements 31b (second driving elements) and the electrodes 34b arranged on the both surfaces of the driving element 31b.

The nozzle 35a in the ejection area 51a and the nozzle 35b in the ejection area 51b are not arranged collinearly with respect to a direction orthogonal to the arrangement direction of the driving element 31. In other words, the nozzle 35a in the ejection area 51a and the nozzle 35b in the ejection area 51b are arranged at positions different from each other with respect to the arrangement direction of the driving element 31.

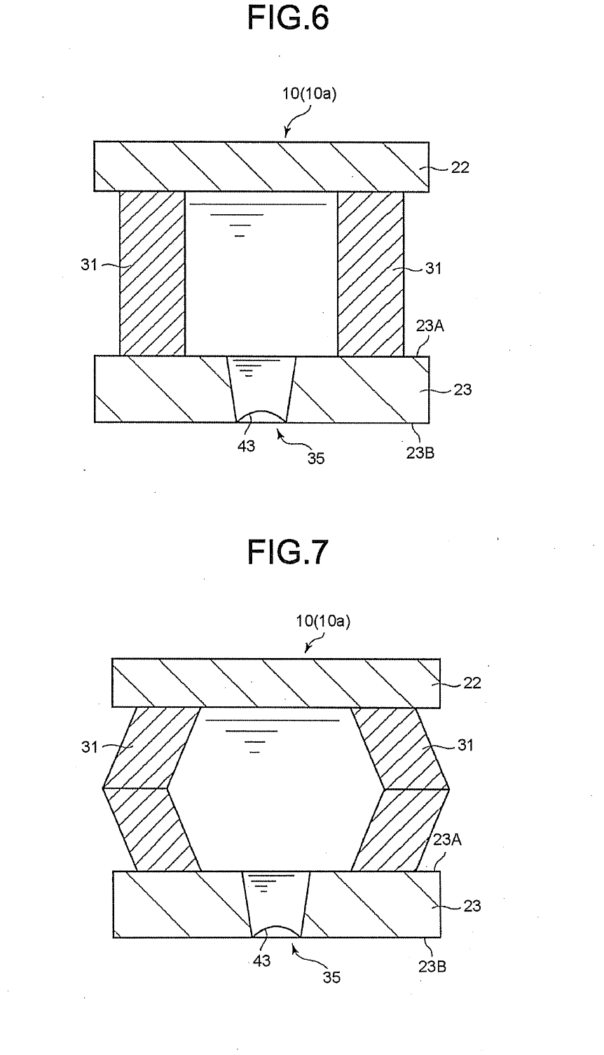

As shown in FIG. 6, the nozzle 35 is formed into, for example, a frustum shape in which the diameter thereof becomes small as it approaches the second surface 23B. The nozzle 35 penetrates the first surface 23A and the second surface 23B. In the inkjet head 10, partition may be arranged between each pressure chamber 32b in the ejection area 51a and each pressure chamber 32b in the ejection area 51b. In this case, the inkjet head 10 is equipped with the supply holes respectively at the ejection area 51a side and at the ejection area 51b side. The two supply holes communicate with the same common liquid chamber. In other words, the common liquid chamber communicates with the pressure chambers 32 in the two ejection areas through the supply holes.

The pressure chamber 32a, the pressure chamber 32b and the common liquid chamber 33 may not be arranged in the same plane. The common liquid chamber 33 may be laminatedly arranged with respect to the pressure chamber 32a and the pressure chamber 32b, existing in the same plane, between which a partition is arranged.

Next, ejection operations of the ink by the inkjet head 10 are described. The ejection operations of the pressure chamber 32a and the pressure chamber 32b are identical, and thus, only the operations of the pressure chamber 32 are described hereinafter.

The inkjet head 10 is a liquid (ink) circulation type inkjet head 10. The ink ejected from the tank is supplied to the pressure chamber 32 via the supply hole 26 and the common liquid chamber 33. The ink which is not ejected in the pressure chamber 32 is collected from the discharge hole 27 to the tank. In this way, in the inkjet head 10, the ink is circulated between the tank and the inside of the inkjet head 10.

FIG. 6 is a cross-sectional view of the pressure chamber 32 along the thickness direction of the nozzle plate 23. The control circuit 14 drives the driving element 31 to increase or decrease the volume of the pressure chamber 32 in order to enable the ink to be ejected from the nozzle 35. The control circuit 14 applies a voltage to the electrode 34 to drive the driving element 31 to increase or decrease the volume of the pressure chamber 32.

FIG. 7 is a diagram illustrating a state in which the control circuit 14 drives the driving element 31 so as to increase the volume of the pressure chamber 32. For example, the control circuit 14 applies a pulse (expansion pulse) which expands the volume of the pressure chamber 32 to the driving element 31. If the control circuit 14 applies the expansion pulse to the driving element 31, as shown in FIG. 7, the driving element 31 deforms towards the outer side of the pressure chamber 32. As a result, the volume of the pressure chamber 32 is increased compared with the initial state (state in FIG. 6).

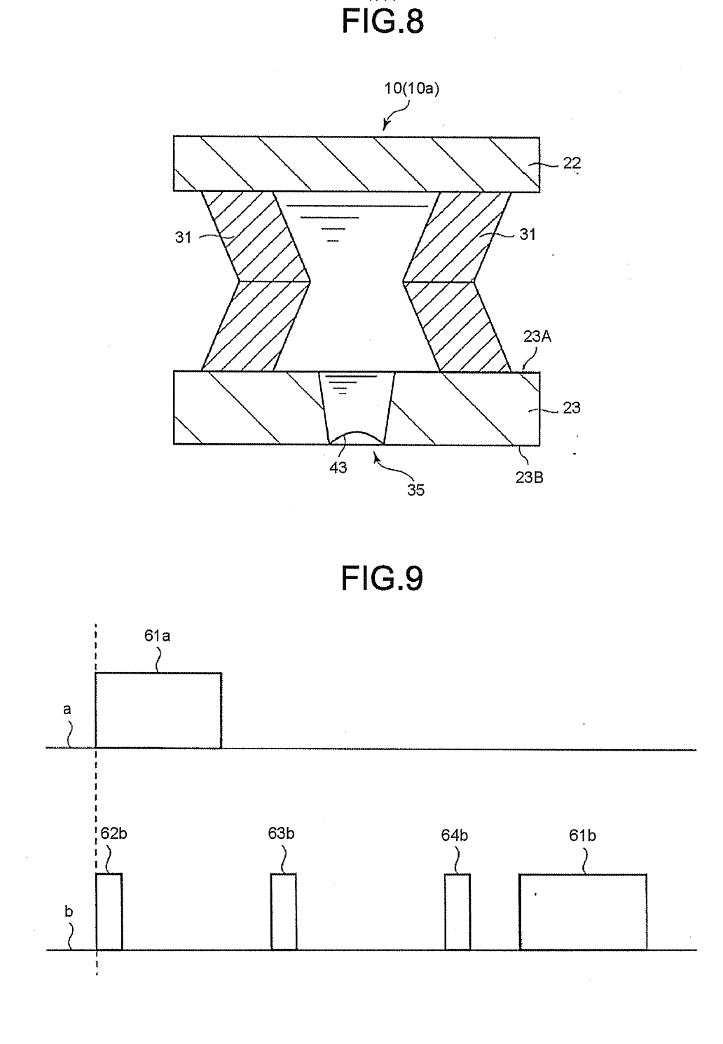

FIG. 8 is a diagram illustrating a state in which the control circuit 14 drives the driving element 31 so as to decrease the volume of the pressure chamber 32. For example, the control circuit 14 applies a pulse (contraction pulse) which contracts the volume of the pressure chamber 32a to the driving element 31a. If the control circuit 14 applies the contraction pulse to the driving element 31, as shown in FIG. 8, the driving element 31 deforms towards the inside of the pressure chamber 32. As a result, the volume of the pressure chamber 32 is decreased compared with the initial state (state in FIG. 6).

After the control circuit 14 temporarily increases the volume of the pressure chamber 32 (state in FIG. 7), if the volume of the pressure chamber 32 is smaller (state in FIG. 8) than the original volume, the liquid in the pressure chamber 32 is pressurized, and the liquid drop from the nozzle 35 is ejected. In other words, the control circuit 14 applies an ejection pulse composed of the expansion pulse and the contraction pulse to the electrode 34 of the driving element 31 to enable the ink to be ejected.

Just before the ejection of the ink, a meniscus surface 43 of the nozzle 35 protrudes towards the external. The protruded ink is ejected as the liquid drop towards the print medium. After the liquid drop is ejected, the meniscus surface 43 of the nozzle 35 retreats towards the inside of the nozzle 35. Further, the waveform of the ejection pulse may be, for example, a waveform changing at a plurality of stages or a rectangular waveform. The configuration of the ejection pulse is not limited to the specific configuration.

Next, an example of operations of the control circuit 14 is described. The control circuit 14 sets the ejection area 51a and the ejection area 51b. The ejection area 51a includes one row of the nozzles 35 predetermined which are arranged in the longitudinal direction of the nozzle plate 23. Similarly, the ejection area 51b includes another row of the nozzles 35 arranged in the longitudinal direction of the nozzle plate 23.

The control circuit 14 enables the ink to be ejected from each ejection area. For example, at the time the print medium passes from the ejection area 51a side, the control circuit 14 enables the ink to be ejected from the ejection area 51a, and sequentially enables the ink to be ejected from the ejection area 51b.

Further, the control circuit 14 sets a channel No for each pressure chamber 32 (channel) in the ejection areas 51a and 51b. For example, the control circuit 14 sets the channel No of each pressure chamber 32 in order from one end of the nozzle plate 23.

The pressure chamber 32 shares the driving element 31 with the respectively adjacent pressure chambers 32. Thus, the control circuit 14 cannot drive each pressure chamber 32 at the same time. Consequently, the control circuit 14 divides the pressure chambers 32 into a plurality of groups every n+1 (n is an integer equal to or greater than 2) channels to drive each group. In the embodiment, the control circuit 14 divides the pressure chambers 32 into three groups every three channels to carry out division driving, in other words, a case of three division driving is exemplified.

The control circuit 14 divides the pressure chambers 32 into No. 3n-2 channel group (first division), No. 3n-1 channel group (second division) and No. 3n channel group (third division) (n is an integer equal to or greater than 1). For example, the control circuit 14 enables the ink to be ejected in the order of the first division, the second division and the third division.

Further, the control circuit 14 may adopt a method (Multi-drop drive) for enabling the ink to be continuously ejected from one channel for many times. For example, the control circuit 14 controls the times that the ink is continuously ejected in response to print data. The inkjet head 10 may carry out binary drive.

Next, the pulse applied to the channel by the control circuit 14 is described. FIG. 9 is a timing chart illustrating an example of the pulse applied to the channel by the control circuit 14. The control circuit 14 enables the ink to be ejected from a predetermined division of the ejection area 51b after enabling the ink to be ejected from a predetermined division of the ejection area 51a.

A waveform a exemplifies a pulse applied to a predetermined division (division a) of the ejection area 51a. A waveform b exemplifies a pulse applied to a division (division b) of the ejection area 51b corresponding to the predetermined division of the ejection area 51a.

As shown in FIG. 9, the control circuit 14 applies an ejection pulse 61a to the division a at a predetermined timing. Further, the control circuit 14 sequentially applies non-ejection pulses 62b to 64b to the division b and then applies the ejection pulse 61b thereto.

The non-ejection pulse is a signal which does not lead to the ejection of the ink. In other words, the non-ejection pulse is a signal which enables the pressure chamber 32 to generate vibration but does not lead to the ejection of the ink. For example, the non-ejection pulse is a signal of which a voltage is smaller than that of the ejection pulse. Further, the non-ejection pulse is a signal of which a width is smaller than that of the ejection pulse. For example, the non-ejection pulse is a rectangular pulse wave. The waveform of the non-ejection pulse is not limited to the specific configuration. In the present embodiment, the non-ejection pulse is set to the rectangular pulse wave. Furthermore, the non-ejection pulse is set to a pulse wave shorter than the ejection pulse.

The control circuit 14 applies at least one non-ejection pulse to the division b until the application of the ejection pulse to the division a is ended. In other words, the control circuit 14 applies a non-ejection pulse to the division b of which the application is ended until an end timing at which the application of the ejection pulse to the division a is ended.

In the example shown in FIG. 9, the control circuit 14 starts to apply the non-ejection pulse 62b to the division b at a timing when the application of the ejection pulse 61a to the division a is started. In other words, the control circuit 14 makes the timing of the start of the ejection pulse 61a of the division a consistent with the timing of the start of the non-ejection pulse 62b of the division b.

After applying the non-ejection pulse 62b to the division b, the control circuit 14 applies the non-ejection pulse 63b to the division b at a predetermined interval. After applying the non-ejection pulse 63b to the division b, the control circuit 14 applies the non-ejection pulse 64b to the division b at a predetermined interval. After applying the non-ejection pulse 64b to the division b, the control circuit 14 applies the ejection pulse 61b to the division b at a predetermined interval.

The interval between the non-ejection pulse 62b and the non-ejection pulse 63b may be identical to or different from that between the non-ejection pulse 63b and the non-ejection pulse 64b. The control circuit 14 may apply three or more non-ejection pulses or only one non-ejection pulse between the non-ejection pulse 62b and the ejection pulse 61b. Further, the control circuit 14 may not apply a non-ejection pulse between the non-ejection pulse 62b and the ejection pulse 61b. Further, the control circuit 14 may apply a non-ejection pulse prior to the non-ejection pulse 62b.

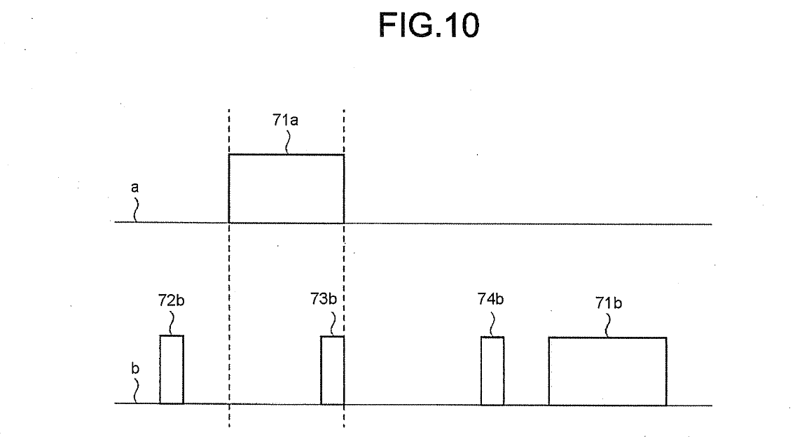

Next, another example of the pulse applied to the channel by the control circuit 14 is described. FIG. 10 is a timing chart illustrating another example of the pulse applied to the channel by the control circuit 14. The control circuit 14 enables the ink to be ejected from the predetermined division of the ejection area 51b after enabling the ink to be ejected from the predetermined division of the ejection area 51a.

As shown in FIG. 10, the control circuit 14 applies an ejection pulse 71a to the division a at a predetermined timing. Further, the control circuit 14 sequentially applies non-ejection pulses 72b to 74b to the division b, and then applies an ejection pulse 71b thereto.

In the example shown in FIG. 10, the control circuit 14 applies the non-ejection pulse 72b to the division b at a predetermined timing before applying the ejection pulse 71a to the division a. If the pulse 72b is applied to the division b, the control circuit 14 applies the non-ejection pulse 73b of which the application is ended at the same timing as the end of the application of the ejection pulse 71a to the division a. In other words, the control circuit 14 makes the timing of the falling of the ejection pulse 71a of the division a consistent with the timing of the falling of the non-ejection pulse 73b.

If the non-ejection pulse 73b is applied to the division b, the control circuit 14 applies a non-ejection pulse 74b to the division b at a predetermined interval. If a non-ejection pulse 74b is applied to the division b, the control circuit 14 applies the ejection pulse 71b to the division b at a predetermined interval.

The interval between the non-ejection pulse 72b and the non-ejection pulse 73b may be identical to or different from that between the non-ejection pulse 73b and the non-ejection pulse 74b. The control circuit 14 may apply two or more non-ejection pulses or may not apply any non-ejection pulse between the non-ejection pulse 73b and the ejection pulse 71b. Further, the control circuit 14 may apply a plurality of non-ejection pulses to the division b while an ejection pulse is applied to the division a.

Next, the pulses applied to each division of the ejection area 51a and each division of the ejection area 51b by the control circuit 14 are described.

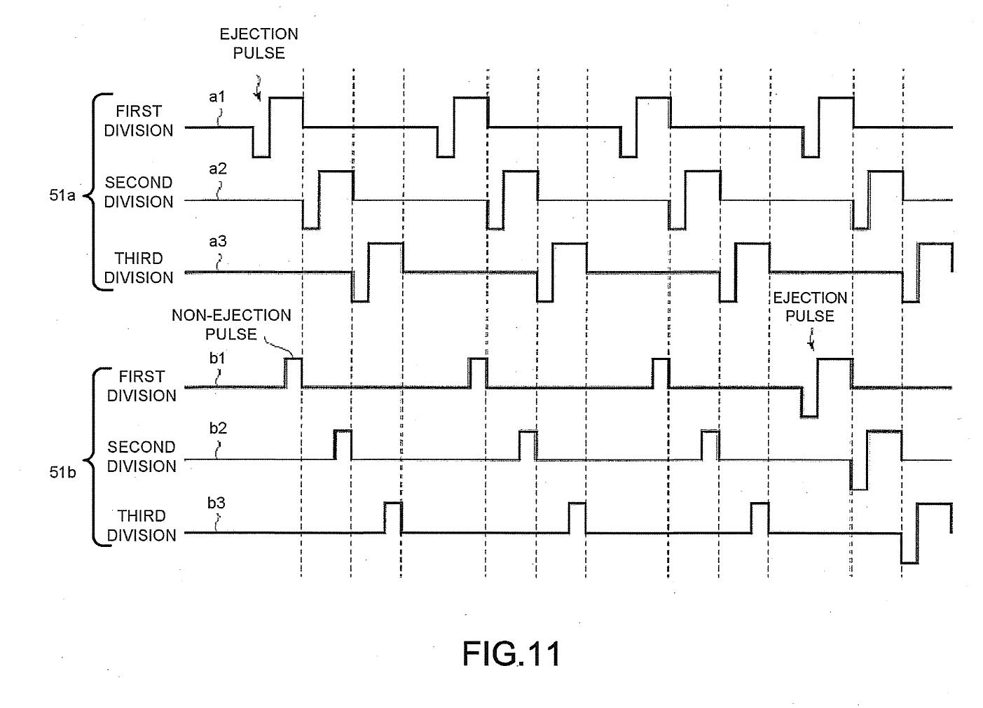

FIG. 11 is a timing chart for describing a concrete example of the pulses applied to each division of the ejection area 51a and each division of the ejection area 51b by the control circuit 14. FIG. 11 illustrates an example (example shown in FIG. 10) in which a timing at which the ejection pulse is ended is consistent with a timing at which the non-ejection pulse is ended.

It is assumed that the control circuit 14 enables the ink to be ejected from each division of the ejection area 51a, and next enables the ink to be ejected from each division of the ejection area 51a and each division of the ejection area 51b. The control circuit 14 enables the ink to be ejected from the first division, the second division and the third division in order.

In FIG. 11, a waveform a1 illustrates an example of a pulse applied to the first division of the ejection area 51a. A waveform a2 illustrates an example of a pulse applied to the second division of the ejection area 51a. A waveform a3 illustrates an example of a pulse applied to the third division of the ejection area 51a. A waveform b1 illustrates an example of a pulse applied to the first division of the ejection area 51b. A waveform b2 illustrates an example of a pulse applied to the second division of the ejection area 51b. A waveform b3 illustrates an example of a pulse applied to the third division of the ejection area 51b.

As shown in FIG. 11, firstly, the control circuit 14 applies an ejection pulse to the first division of the ejection area 51a. Further, the control circuit 14 applies a non-ejection pulse to the first division of the ejection area 51b of which the application is ended at the same timing as the end of the application of the ejection pulse.

If the ejection pulse is applied to the first division of the ejection area 51a and the non-ejection pulse is applied to the first division of the ejection area 51b, the control circuit 14 applies an ejection pulse to the second division of the ejection area 51a. Further, the control circuit 14 applies a non-ejection pulse to the second division of the ejection area 51b of which the application is ended at the same timing as the end of the application of the ejection pulse.

If the ejection pulse is applied to the second division of the ejection area 51a and the non-ejection pulse is applied to the second division of the ejection area 51b, the control circuit 14 applies an ejection pulse to the third division of the ejection area 51a. Further, the control circuit 14 applies a non-ejection pulse to the third division of the ejection area 51b of which the application is ended at the same timing as the end of the application of the ejection pulse is ended.

Similarly, the control circuit 14 applies the ejection pulses to the first division, the second division and the third division of the ejection area 51a. Further, similarly, the control circuit 14 applies the non-ejection pulse to the first division, the second division and the third division of the ejection area 51b.

Further, the control circuit 14 simultaneously applies the ejection pulse to the first division of the ejection area 51b and the ejection pulse to the first division of the ejection area 51a at a predetermined timing. For example, the control circuit 14 applies the ejection pulses to the first divisions of both ejection areas at a timing when the paper P is conveyed to a position where the ejection area 51b ejects the ink. If the ejection pulses are applied to the first divisions of both ejection areas, the control circuit 14 applies the ejection pulses to the second divisions of both ejection areas. If the ejection pulses are applied to the second divisions of both ejection areas, the control circuit 14 applies the ejection pulses to the third divisions of both ejection areas.

Furthermore, the control circuit 14 may not apply the ejection pulse to a predetermined division of the ejection area 51a at a predetermined timing. For example, the control circuit 14 may apply a non-ejection pulse to the predetermined division of the ejection area 51a before an end timing of the ejection pulse applied to a predetermined division of the ejection area 51b.

In a case in which ink drops are ejected the number of which meets the maximum ejection number from a predetermined channel, the control circuit 14 may apply the non-ejection pulse to an empty part of the ejection pulse (in other words, at the timing of applying the ejection pulse in a case of ejecting the maximum ejection number). Further, the control circuit 14 may apply the non-ejection pulse to a part of the empty part.

Next, a relation between a width of the non-ejection pulse and ejection failure is described.

Firstly, printing failure generated in the inkjet head 10 is described.

According to the embodiment, the inkjet head 10 is equipped with the ejection areas 51a and 51b. The inkjet head 10 ejects the ink ahead from either of the ejection areas 51a and 51b. If the inkjet head 10 ejects the ink from an initial ejection area (for example, the ejection area 51a), pressure (nozzle negative pressure) of the pressure chamber 32 of the ejection area, the common liquid chamber 33 communicating with the pressure chamber and the pressure chamber 32 of the other ejection area (for example, the ejection area 51b) communicating with the common liquid chamber 33 is reduced.

In a case of ejecting the ink from the ejection area 51b after ejecting the ink from the ejection area 51a, the inkjet head 10 ejects the ink from the ejection area 51b in most cases in a state in which the nozzle negative pressure is lower than that before the ejection of the ink. If the inkjet head 10 ejects the ink in a state in which the nozzle negative pressure is lower, the ejection failure (for example, blurring or decrease in an ejection volume) occurs in most cases. In other words, the inkjet head 10 is easy to generate the ejection failure if the nozzle negative pressure before the ejection of the ink is low.

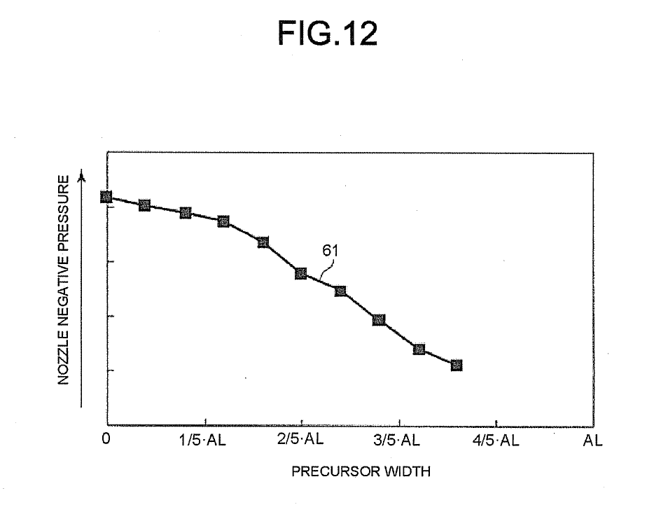

FIG. 12 is a diagram illustrating the relation between the width of the non-ejection pulse and the ejection failure.

The horizontal axis shown in FIG. 12 indicates the width of the non-ejection pulse. AL refers to half of time of a natural vibration period for which the nozzle negative pressure changes. The vertical axis shown in FIG. 12 indicates the nozzle negative pressure before the ejection of the ink.

A graph 61 shown in FIG. 12 indicates the nozzle negative pressure generated by the ejection failure. In other words, in a case in which the nozzle negative pressure is lower than a graph 61 (in other words, in a case in which the nozzle negative pressure is below the graph 61), the ejection failure is generated.

As shown in FIG. 12, the larger the width of the non-ejection pulse is, the lower the graph 61 is. Thus, FIG. 12 illustrates that the nozzle negative pressure generated by the ejection failure is decreased as the width of the non-ejection pulse is increased. In other words, as the width of the non-ejection pulse is increased, a negative pressure area where the ink is stably ejected can be enlarged.

Next, a modification of the inkjet printer is described.

An inkjet printer 100′ according to the modification is different from the inkjet printer 100 shown in FIG. 1 is that the driving element 31 and the electrode 34 are formed at a predetermined angle with the row of the nozzle 35. Thus, the configuration except that is applied to the same reference numerals, and the detailed description thereof is omitted. In the modification, the inkjet printer 100′ is equipped with an inkjet head 10′.

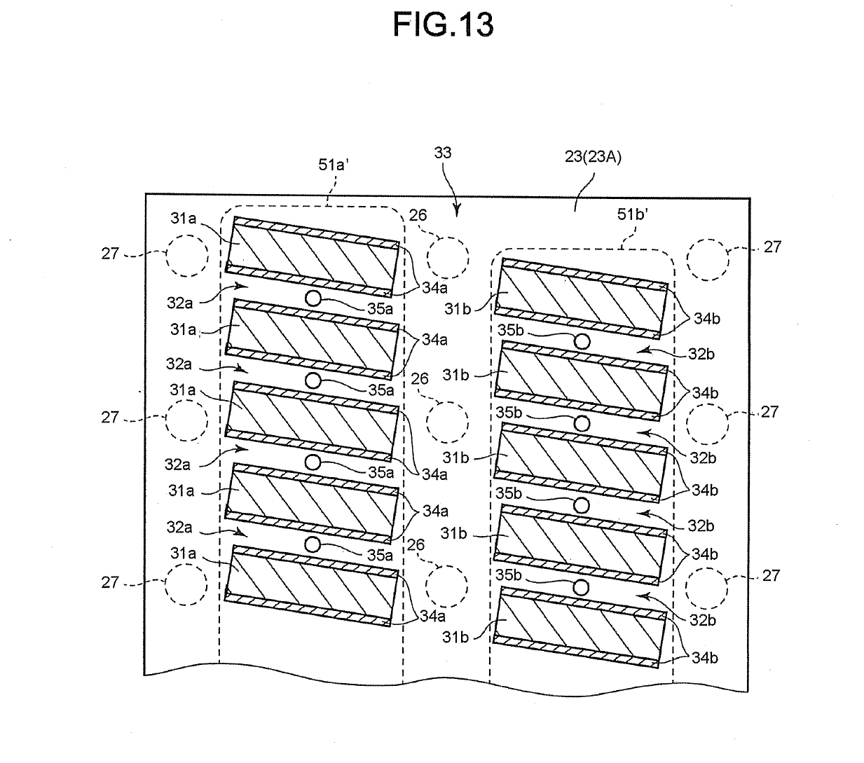

FIG. 13 is a cross-sectional view of the inkjet head 10′ taken along the F4-F4 line.

As shown in FIG. 13, the inkjet head 10′ is equipped with two rows (a plurality of rows) of plural driving elements 31a and 31b, arranged in one direction, which are parallel to each other. In FIG. 13, the inkjet head 10′ is equipped with an ejection area 51a′ and an ejection area 51b′. The ejection area 51a′ is equipped with the driving elements 31a arranged at the left side. The ejection area 51b′ is equipped with the driving elements 31b arranged at the right side.

The driving element 31a is formed at the predetermined angle with respect to the arrangement direction of the driving element 31. In other words, the driving element 31a is formed in such a manner that the longitudinal direction of the driving element 31a is not orthogonal to the arrangement direction of the driving element 31. Similarly, the driving element 31b is formed at the predetermined angle with respect to the arrangement direction of the driving element 31. In other words, the driving element 31b is formed in such a manner that the longitudinal direction of the driving element 31b is not orthogonal to the arrangement direction of the driving element 31.

Further, the driving element 31a and the driving element 31b may be formed in such a manner that both wall surfaces formed in the longitudinal direction of the driving element 31a and both wall surfaces formed in the longitudinal direction of the driving element 31b are on the same straight line.

The nozzle 35a in the ejection area 51a′ and the nozzle 35b in the ejection area 51b′ are not arranged on the same line with respect to the direction orthogonal to the arrangement direction of the driving element 31. In other words, the nozzle 35a in the ejection area 51a′ and the nozzle 35b in the ejection area 51b′ are arranged at positions different from each other with respect to the arrangement direction of the driving element 31.

The inkjet head constituted as stated above can apply the non-ejection pulse to the division of the ejection area where the ink is not ejected at the timing of applying the ejection pulse. As shown in FIG. 12, by applying the non-ejection pulse to the division of the ejection area where the ink is not ejected, the nozzle negative pressure generated by the ejection failure is decreased. As a result, the inkjet head can enlarge a range of settable nozzle negative pressure. In other words, the inkjet head can suppress the ejection failure without increasing the nozzle negative pressure. Thus, the inkjet head can easily reduce the ejection failure.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An inkjet head, comprising:
a plurality of first driving elements comprising a plurality of first pressure chambers respectively communicating with a plurality of first nozzles;
a plurality of second driving elements comprising a plurality of second pressure chambers respectively communicating with a plurality of second nozzles;
a common liquid chamber configured to communicate with a plurality of the first pressure chambers and a plurality of the second pressure chambers; and
a controller configured to apply an ejection pulse to the plurality of first driving elements and at least one non-ejection pulse to the plurality of second driving elements before an end time of the ejection pulse.

2. The inkjet head according to claim 1, wherein
the controller respectively divides a plurality of the first pressure chambers and a plurality of the second pressure chambers into a plurality of subgroups, and applies the ejection pulse to one subgroup of the first pressure chambers and the non-ejection pulse to one subgroup of the second pressure chambers corresponding to the one subgroup of the first pressure chambers.

3. The inkjet head according to claim 2, wherein
a plurality of the second driving elements is arranged in parallel to an arrangement direction of a plurality of the first driving elements, and the first nozzles and the second nozzles are arranged at positions different from each other with respect to the arrangement direction.

4. The inkjet head according to claim 1, wherein
the non-ejection pulse is ended at a time when application of the ejection pulse to the plurality of first driving element is ended.

5. An inkjet printer, comprising:
an inkjet head; and
a supply section configured to supply a print medium on which an image is formed with ink ejected by the inkjet head, wherein the inkjet head comprising:
a plurality of first driving elements comprising a plurality of first pressure chambers respectively communicating with a plurality of first nozzles;
a plurality of second driving elements comprising a plurality of second pressure chambers respectively communicating with a plurality of second nozzles;
a common liquid chamber configured to communicate with a plurality of the first pressure chambers and a plurality of the second pressure chambers; and
a controller configured to apply an ejection pulse to the plurality of first driving elements and at least one non-ejection pulse to the plurality of second driving elements before an end time of the ejection pulse.

6. The inkjet printer according to claim 5, wherein
the controller respectively divides a plurality of the first pressure chambers and a plurality of the second pressure chambers into a plurality of subgroups, and applies the ejection pulse to one subgroup of the first pressure chambers and the non-ejection pulse to one subgroup of the second pressure chambers corresponding to the one subgroup of the first pressure chambers.

7. The inkjet printer according to claim 6, wherein
a plurality of the second driving elements is arranged in parallel to an arrangement direction of a plurality of the first driving elements, and the plurality of first nozzles and the plurality of second nozzles are arranged at positions different from each other with respect to the arrangement direction.

8. The inkjet printer according to claim 5, wherein
the non-ejection pulse is ended at a time when application of the ejection pulse to the plurality of first driving element is ended.

9. An inkjet printing method for the inkjet head of claim 1, comprising:
applying simultaneously an ejection pulse to a plurality of first driving elements and a non-ejection pulse to a plurality of second driving elements.

10. The inkjet printing method according to claim 9, wherein
applying comprises applying the ejection pulse to one subgroup of first pressure chambers of the first driving elements and the non-ejection pulse to one subgroup of the second pressure chambers of the second driving elements corresponding to the one subgroup of the first pressure chambers.

11. The inkjet printing method according to claim 9, wherein
the non-ejection pulse is ended at a time when applying the ejection pulse to the plurality of first driving elements is ended.

12. The inkjet printing method according to claim 9, wherein
the non-ejection pulse is a signal of which a voltage is smaller than a voltage of the ejection pulse.

13. The inkjet printing method according to claim 9, wherein
the non-ejection pulse is a signal of which a width is smaller than a width of the ejection pulse.

14. The inkjet printing method according to claim 9, wherein
the non-ejection pulse is set to a pulse wave shorter than the ejection pulse.
